(19) United States
(12) Patent Application Publication
(10) Pub. No.: US 2012/0148915 A1
(43) Pub. Date: Jun. 14, 2012

(54) POSITIVE ELECTRODE AND BATTERY USING THE SAME

(75) Inventor: Chungpin Liao, Taichung (TW)

(73) Assignee: INNOT BIOENERGY HOLDING CO., George Town (KY)

(21) Appl. No.: 13/076,345

(22) Filed: Mar. 30, 2011

(30) Foreign Application Priority Data
Dec. 13, 2010 (CN) 201010585286.6

(51) Int. Cl. H01M 4/60; B05D 5/12; H01M 4/04

(52) U.S. Cl. 429/209; 427/77

(57) ABSTRACT

A positive electrode is provided in the present invention. The positive electrode includes a first element having a top surface, and an opposite, a bottom surface, comprising a conductive polymeric material and a second element is deposited on the top surface of the first element. The second element includes a composite material. A battery with the positive electrode is also provided according to one embodiment of the present invention.

### CROSS-REFERENCE TO RELATED APPLICATION

This application claims priority of Chinese Patent Application No. 201010585286.6, filed on Dec. 13, 2010, entitled “Positive Electrode And Battery Using The Same” by Chungpin Liao, the disclosure of which is incorporated herein by reference in its entirety.

### FIELD OF THE INVENTION

The present invention relates to an electrode, and more particularly to a positive electrode and a battery using the positive electrode.

### BACKGROUND OF THE INVENTION

In recent years, mobile phones, digital cameras, notebook computers, digital video cameras, personal digital assistants (PDAs), CD players, as well as other portable electronic devices, are becoming popular owing to their lightweight and small size. As a consequence, batteries used to power these portable devices have also become the focus of public concern. There are different types of batteries, including dry batteries, alkaline batteries, nickel-hydrogen batteries, etc.

Although some new types of zinc-carbon batteries, alkaline batteries, and secondary batteries are allegedly environment-benign, they in fact largely contain substantial amounts of mercury and other heavy metals, such as the cobalt. Other than that, environmental pollutants are frequently used or released during the manufacturing processes of such batteries.

Lithium batteries, though widely adopted as the largest energy content among portable batteries, are unstable in the electrochemical reactions. In the worst case, explosions may occur due to thermal runaway as the result of operating at low load or under improper assemblage. The price of the lithium batteries rises rapidly as a result of the depletion of lithium mineral.

### SUMMARY OF THE INVENTION

The present invention provides a positive electrode and a battery using the positive electrode that solved the problems encountered with conventional battery of high internal resistance and environmental pollution. The advantages of the present invention will be understood more readily after a consideration of the drawings and the detailed description of the preferred embodiments.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a positive electrode according to an embodiment of the present invention; and

FIG. 2 is a flow chart illustrating a manufacturing process of the positive electrode of FIG. 1 according to an embodiment of the present invention.

### DETAILED DESCRIPTION OF THE INVENTION

Reference will now be made to the drawings to describe an exemplary embodiment in detail.

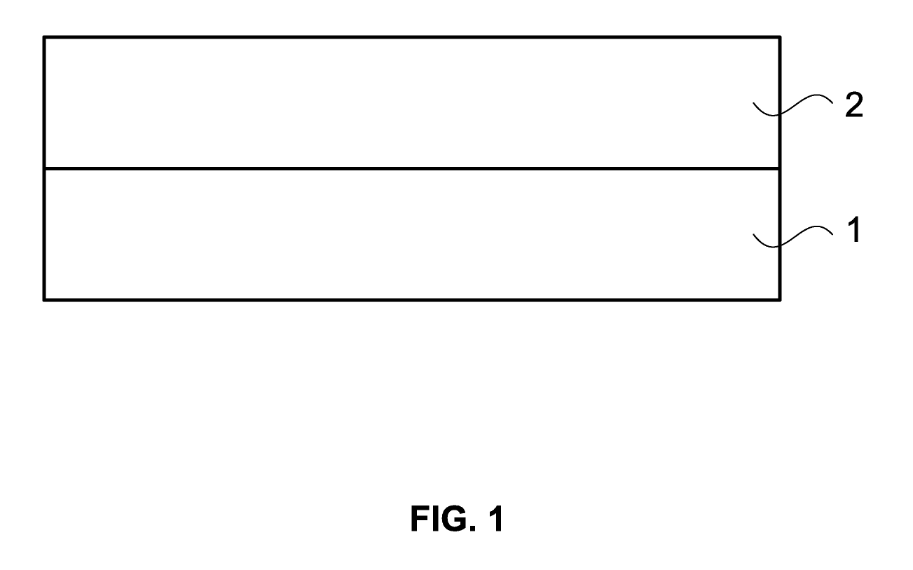

FIG. 1 is a schematic view of a positive electrode according to an embodiment of the present disclosure. As shown in FIG. 1, the positive electrode has a first element 1 and a second element 2 formed on the first element 1.

The first element 1 is a conductive polymeric material. The conductive polymeric material may be selected from the group consisting of heterocycle and aromatic heterocyclic compound. Preferably, the conductive polymeric material is selected from the group consisting of polyacetylene, poly(arylene vinylene), polythiophene, polyaniline, polypyrrole, and the derivatives thereof.

In one embodiment, the first element 1 is a membrane formed with conductive polymeric material. The thickness of the membrane is about 1 mm and the size of the membrane is about 5 cm×10 cm.

In one embodiment, the second element 2 is a composite material containing carbon, the allotropes of carbon or nanometer conductive polymeric material. Carbon and the allotropes of carbon are selected from the group consisting of white carbon or Chaoite, carbon black, glassy carbon, diamond, amorphous carbon, graphene, fulerene, graphite, carbyne, diatomic carbon, tricarbon, atomic carbon, graphitizable carbon, pyrolytic carbon, coke and other allotropes of carbon.

Carbon and the allotropes of carbon can be in the shape of powder or cloth. The nanometer conductive polymeric material may be in the shape of powder or membrane. Any known method can be used to form the second element 2 on the first element 1. For example, the carbon, the allotropes of carbon or nanometer conductive polymeric material in powder or cloth form may be formed on the first element 1 by suppressing. The nanometer conductive polymeric material in liquid form can be formed as a membrane on the first element 1 by spreading.

The weight of the second element 2 is about 0.1 g. The thick of the second element is in a range from about 0.05 mm to about 0.2 mm. The composite material may have pores and the diametric length of each pore is preferably about 3 Å to 1000 Å.

The positive electrode obtained according to the above embodiment may be used to produce a battery.

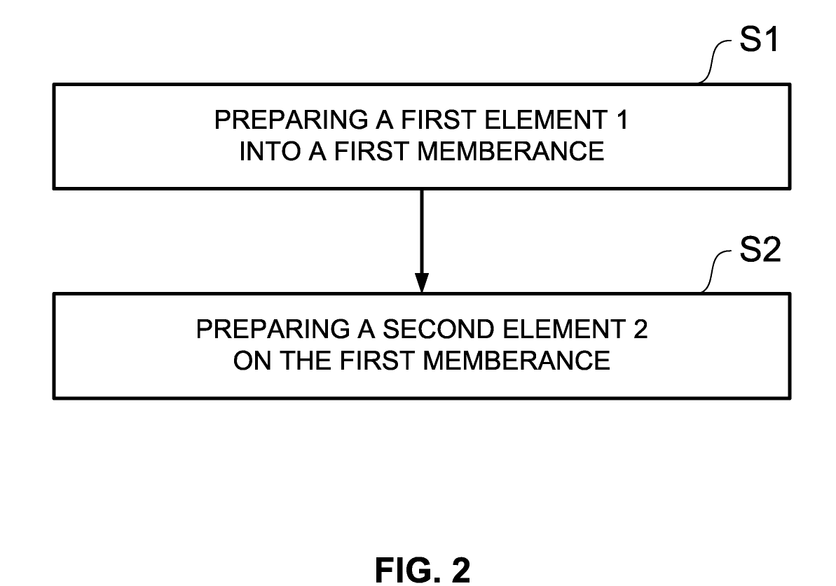

Referring to FIG. 2, a manufacturing process of the positive electrode mentioned above is shown according to one embodiment of the present invention. The process includes the following steps:

step S1, preparing a first element 1 into a first membrane; and

step S2, preparing a second element 2 on the first membrane.

Any known method can be used to complete the step S1. The second element 2 is deposited on the first element 1 by suppressing or by spreading as mentioned above.

The positive electrode of the present invention has wide variety of sources of raw materials and outstanding characteristics of low internal resistance. Not only is the manufacturing process of the positive electrode simple and economical, but also natural, non-toxic substances are employed, unlike conventional batteries and solar cells, the battery of the present invention will not cause environmental pollution even when discarded after being used.

It should be noted that the terms “first”, “second” and other terms in the present disclosure are only used as textual symbols as the circumstances may require, and thus the practice is not limited to these terms. It should be further noted that these terms can be used interchangeably.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of present disclosure to the full extent indicated by the broadest general meaning of the terms in which the appended claims are expressed.

What is claimed is:

1. A positive electrode, comprising:
(a) a first element comprising a conductive polymeric material; and
(b) a second element comprising a composite material, deposited on the first element.

2. The positive electrode of claim 1, wherein the conductive polymeric material is selected from the group consisting of heterocycle and aromatic heterocyclic compound.

3. The positive electrode of claim 1, wherein the conductive polymeric material is selected from the group consisting of polyacetylene, poly(arylene vinylene), polythiophene, polyaniline, polypyrrole, and the derivatives thereof.

4. The positive electrode of claim 1, wherein the composite material comprises carbon, the allotropes of carbon or a nanometer conductive polymeric material.

5. The positive electrode of claim 4, wherein the carbon and the allotropes of carbon is selected from the group consisting of white carbon or Chaoite, carbon black, glassy carbon, diamond, amorphous carbon, graphene, fulerene, graphite, carbyne, diatomic carbon, tricarbon, atomic carbon, graphitizable carbon, pyrolytic carbon and coke.

6. The positive electrode of claim 4, wherein the conductive polymeric material is in the shape of powder or membrane.

7. The positive electrode of claim 1, wherein the first element comprises a membrane formed by the conductive polymeric material.

8. The positive electrode of claim 7, wherein the thickness of the membrane is about 1 mm and the size of the membrane is about 5 cm×10 cm.

9. The positive electrode of claim 1, wherein the weight of the second element is about 0.1 g.

10. The positive electrode of claim 1, wherein the composite material has pores each with a size ranging from about 3 Å to about 1000 Å.

11. The positive electrode of claim 1, wherein the thickness of the second element is in a range from about 0.05 mm to about 0.2 mm.

12. The positive electrode of claim 1, wherein the second element is disposed on the first element by suppressing or spreading.

13. A battery comprising the positive electrode of claim 1.
